(19) United States
(12) Patent Application Publication
(10) Pub. No.: US 2009/0015397 A1
(43) Pub. Date: Jan. 15, 2009

(54) EMERGENCY LIGHT SYSTEM

(75) Inventors: DAVID J. EARDLEY, CHARDON, OH (US); NORBERT J. TOBBE, CHAGRIN FALLS, OH (US); JOHN E. WATKINS, PITTSBURGH, PA (US)

Correspondence Address: Emerson, Thomson & Bennett, LLC, 777 W. Market Street, Akron, OH, 44303, US

(73) Assignee: ALLERT ALL, INC., CHARDON, OH (US)

(21) Appl. No.: 12/170,800

(22) Filed: Jul. 10, 2008

Related U.S. Application Data
(60) Provisional application No. 60/948,705, filed on Jul. 10, 2007.

(51) Int. Cl. H04Q 7/00; H04M 11/04

(52) U.S. Cl. 340/539.11; 379/40

(57) ABSTRACT

An emergency communication device is disclosed herein, including a substantially enclosed housing, at least one receiver, at least one transformer, at least one latching relay, at least one power supply, wherein the receiver, transformer, latching relay, and power supply are located within the housing, a telephone cord, an automatic dialer, wherein the automatic dialer is operatively connected to the housing, and is operatively connected to at least the power supply, and a flashing light.

### I. BACKGROUND

This application claims priority to a provisional patent application, Ser. No. 60/948,705, entitled Emergency Beacon, filed Jul. 10, 2007, which is incorporated by reference. This invention pertains to the art of methods and apparatuses regarding emergency correspondence, and more specifically to apparatuses and methods regarding emergency lighting and communication systems.

### II. BRIEF DESCRIPTION OF THE DRAWINGS

The invention may take physical form in certain parts and arrangement of parts, at least one embodiment of which will be described in detail in this specification and illustrated in the accompanying drawings which form a part hereof and wherein:

FIG. 1 is a perspective view of the invention;

FIG. 2 is a perspective view of an auto-dialer;

FIG. 3 is a perspective view of a revolving light;

FIG. 4 is a perspective view of a receiver, transformer, latching relay, power supply, and battery;

FIG. 5 is a perspective view of a two-way communications device; and,

FIG. 6 is a perspective view of a speaker/microphone.

### III. DETAILED DESCRIPTION

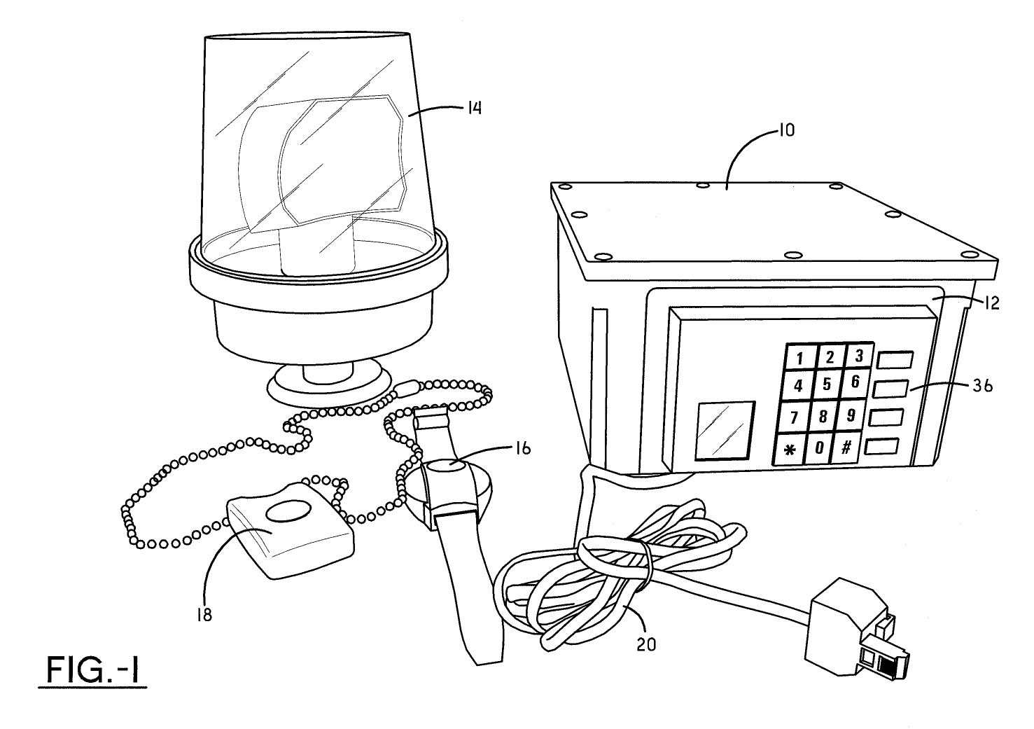

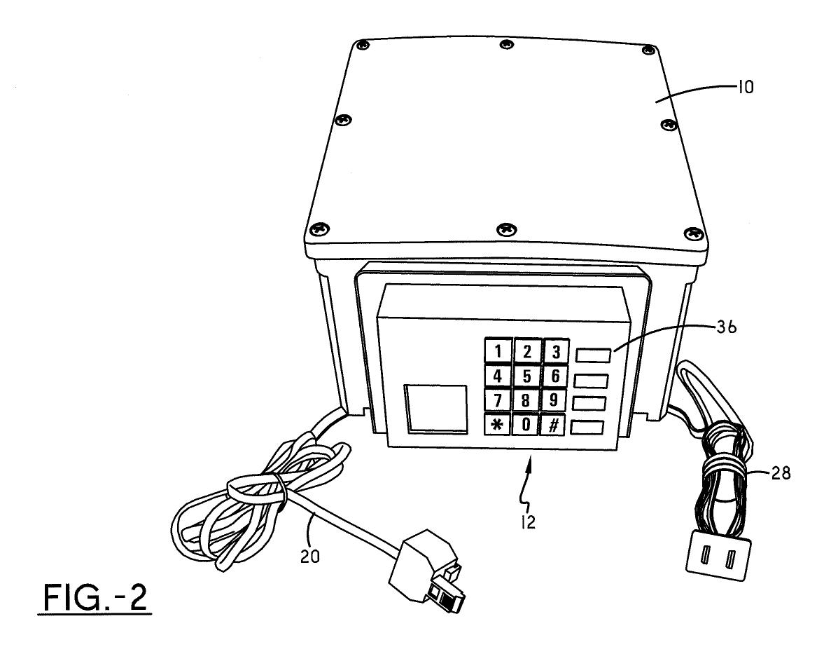

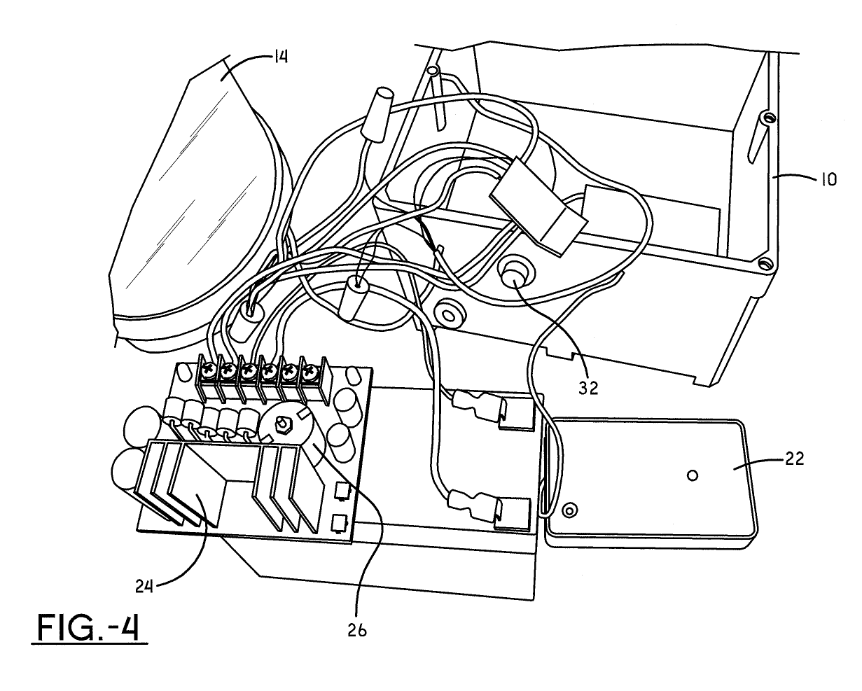

With reference now to FIGS. 1-4, the FIGURES show a housing 10, an auto-dialer 12, a flashing light 14, a wrist transmitter 16, a pendant transmitter 18, a phone cord 20, a receiver 22, a transformer 24, a latching relay 26, and a power supply 28. The receiver 22, transformer 24, and latching relay 26, in this embodiment, are located within the housing 10. In one embodiment, the automatic dialer 12 is a two-channel programmable speech dialer. Each channel can be reported to four different phone numbers, or both events can be reported to the same four telephones. The front-panel keyboard 36 facilitates programming of the calling numbers, configuration of various operation parameters, and testing of the alarm functionality. In this embodiment, the automatic dialer 12 is designed to accept relay inputs, or switch closures, to trigger the alarm channels. An interface is provided to convert the digital outputs of the control module to an acceptable relay type input, such as an optically isolated solid-state relay.

With continued reference to FIGS. 1-4, the automatic dialer 12 process, in this embodiment, is as follows: the dialer starts dialing if uninterrupted tone is detected from two seconds. If five seconds elapse with no dial tone, the dialer disengages the line, waits five seconds and tries again. If another five seconds go by without dial tone, the dialing procedure starts anyway. The dialer dials a programmed number. The wireless transmitter can either be a wrist transmitter 16 or a pendant transmitter 18. The wireless transmitter enables the user to transmit a signal either directly to emergency personnel, or to the automatic dialer 12, or to the flashing light 14. It is also to be understood that the wireless transmitters could be configured to allow transmission of a signal to all three. In one residential application the wireless transmitter is electrically connected as a switch between a power supply 28 and the light 14 such that when the user pushes a button in an emergency, the receiver will be triggered to switch on the power for the light 14. In one embodiment, the power is residential 110 volt AC and wiring is accomplished by using line cords with standard plugs for wall receptacles. A reset button 32 is located on the side of the housing 10. The reset button 32 allows the device to be turned off manually. In one embodiment, the device will not turn off unless the reset button 32 has been depressed. The reset button 32 is operated by the relay 26.

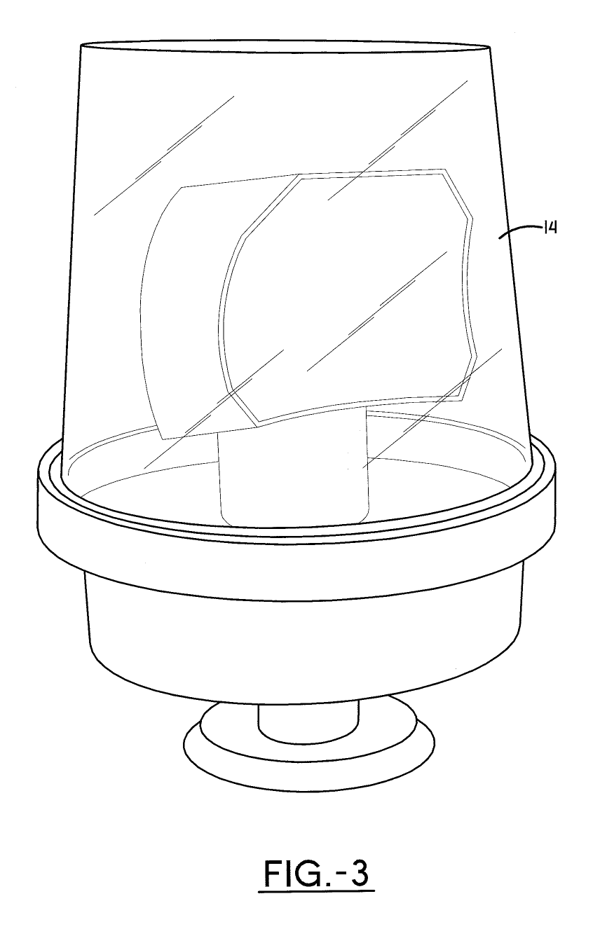

With reference now to FIG. 3, the flashing light 14 is an attention-getting light that is turned on by an individual when they are experiencing an emergency situation in order to alert bystanders to a problem that they can report to authorities and/or can investigate to determine a proper response. Additionally, the light 14 helps direct emergency responders to the correct location of a reported emergency. The light 14 is attention-getting due to its color (e.g., red) and flashing, blinking, nature of illumination. One embodiment is for residential use, where the light 14 can be mounted in a window or on a public and/or street-visible part of the building's exterior. The light 14 can be mounted on any substantially flat surface, as long as chosen using sound engineering judgment. In another embodiment, the light 14 can simulate a rotating light by having a series of LED lights that are turned on and off in sequence.

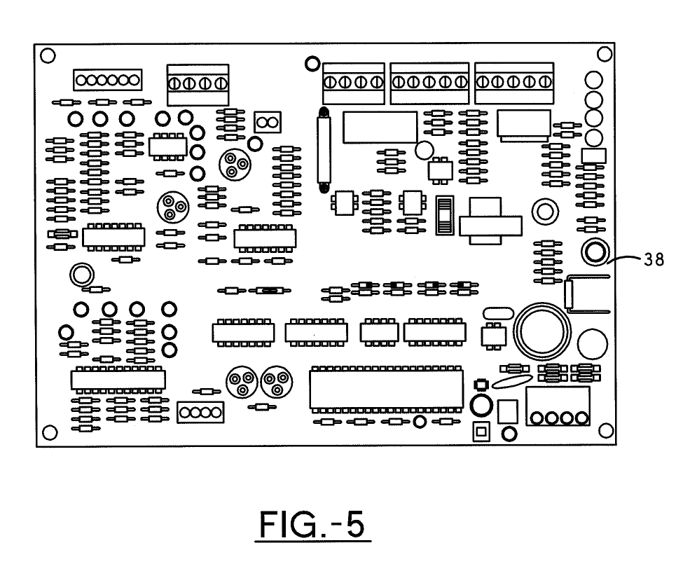

With reference now to FIG. 5, in another embodiment, the device has a two-way communications device 38 is integrated with the automatic dialer 12. The two-way communications device 38 allows emergency phone auto dialer 12 interface, and means for a user to communicate quickly and effectively with emergency personnel. In this embodiment, the two-way communications device 38 is located within the housing 10. One example of the two-way communications device is the Terminator™ Vox Pro from Eagle Security Products of Buffalo, N.Y.

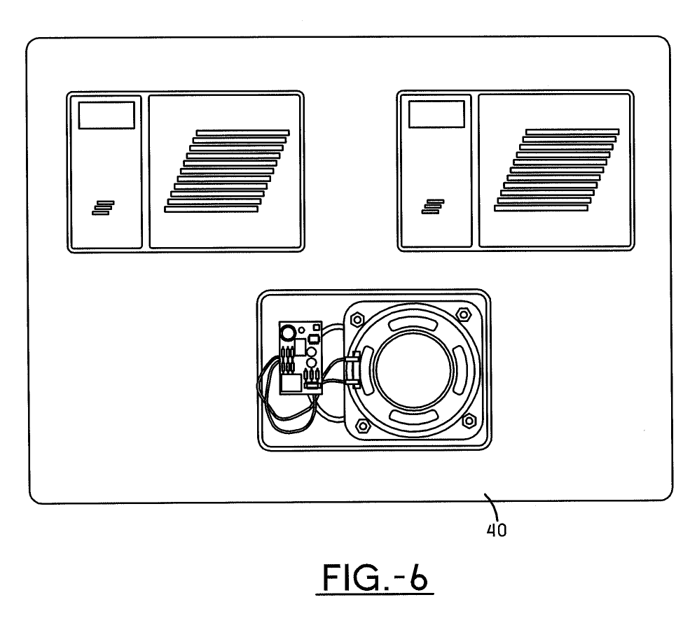

With reference now to FIG. 6, in another embodiment, the device has a speaker/microphone 40. In this embodiment, the speaker/microphone 40 works in conjunction with the two-way communications device 38 in order to allow for effective communication with emergency personnel. In this embodiment, the speaker/microphone is connected to the housing 10. One example of the speaker/microphone is the Eagle Model 2172 from Eagle Security Products of Buffalo, N.Y.

In another embodiment, the inventive device can be used for security purposes in business establishments. It is to be understood that the device can be used for any purpose chosen using sound business and engineering judgment.

In one embodiment the flashing light 14 is similar to the light ordinarily mounted atop a police car, which is powered by the vehicle battery, is waterproof, less than 6 inches in height and supported by a square or circular base less than 5 inches square. The light emitted is quite noticeable day or night and in different colors. The revolving, flashing light 14, in this embodiment, serves as an attention getter, and like emergency vehicles, the blinking can be accomplished by any means such as, for example, switching, rotating reflector, and any other means chosen using sound engineering judgment.

The device could operate on any power source, such as 110 volt AC conventional residential power. In one embodiment, the device is activated by a small, remote, wireless push button transmitter 16, 18. These are available in neck pendent style 18, watchband/bracelet 16, small hand carried unit, or in mountable form for mounting under a counter, table or desk, or wall mounted. The light 14 can be used indoors as well as outdoors. In one embodiment, the light cord is plugged into the housing 10, which is then plugged into a standard 110 volt AC receptacle. Upon detecting a signal, the light 14 is powered.

The flashing light 14, placed on the indoor window sill or attached to the exterior of the residence will illuminate the entire area with flashes that can be visible for miles and notify the neighbors and/or public of an existent emergency within. The saturation of the market with the cell phone will automatically enable alerted observers to call the police or invade the premise to determine the situation. In this embodiment, the light 14 expedites the ability of the professional to pin point the exact residence seeking aid. Even though emergency responders such as EMS, police, and firemen may be aware of the address, all residences do not have their home or apartment number visible or legible, thus making it difficult regardless of how familiar the responders may be with the surroundings. Thus, in many instances, establishment of the exact residence in trouble consumes a perplexing span of time, particularly at night. The brilliant, flashing light 14 negates the problem immediately.

In another embodiment the flashing light 14 is combined with the automatic dialer 12, which can be activated by the wireless transmitter 16, 18. The wireless transmitter 16, 18 and automatic dialer 12 can be used in conjunction with existing alert devices. The wireless transmitter 16, 18 can be connected with any existing alert device.

In another embodiment for a security application, the device comprises the flashing light 14, the automatic dialer 12, and a wireless remote transmitter 16, 18, which will activate the light 14. Of course the flashing light 14 could also be hard wired to a switch. The flashing light 14 can be placed above floor level in a window, illuminating both the interior of the building and the area outside. Alternatively, the light 14 can be strategically placed on the exterior of the building. Additional lights 14 can be utilized if desired e.g., one inside and one or more outside.

In another embodiment, a lithium battery could be used instead of a transformer. The battery would supply power to the device, while the power cord would still be used to provide back-up power, or re-charge the battery. In another embodiment, a plug-in transformer could be used, which would eliminate the need for the power supply.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

I/We claim:

1. An emergency communication device, the device comprising:
a substantially enclosed housing;
at least one receiver;
at least one transformer;
at least one latching relay;
at least one power supply, wherein the receiver, transformer, latching relay, and power supply are located within the housing;
a telephone cord;
an automatic dialer, wherein the automatic dialer is operatively connected to the housing, and is operatively connected to at least the power supply; and,
a flashing light.

2. The device of claim 1, wherein the device further comprises:
at least one wireless transmitter, wherein the wireless transmitter is capable of causing the flashing light to operate.

3. The device of claim 2, wherein the wireless transmitter is at least one of the group comprising wrist-worn transmitter and pendant transmitter, wherein the wireless transmitter is capable of operating the automatic dialer.

4. The device of claim 3, wherein the device further comprises:
a microphone; and,
at least one speaker.

5. The device of claim 4, wherein the device further comprises a two-way communications device.

6. The device of claim 5, wherein the flashing light has an independent power source.

7. The device of claim 1, wherein the flashing light is remote from the housing and is selectively removable from substantially flat surfaces.

8. The device of claim 7, wherein the telephone cord is operatively connected to the auto-dialer.

9. The device of claim 3, wherein the transmitter is remote from the housing.

10. The device of claim 1, wherein the flashing light is not a strobe light.

11. The device of claim 5, wherein the two-way communications device is located on the wireless transmitter.

12. The device of claim 11, wherein the flashing light is a revolving, red light.

13. The device of claim 1, wherein the power supply is a battery.

14. The device of claim 1, wherein the device further comprises a reset button.

15. A method for communicating an emergency, the method comprising the steps of:
providing a substantially enclosed housing, at least one receiver, at least one transformer, at least one latching relay, at least one power supply, wherein the receiver, transformer, latching relay, and power supply are located within the housing, a telephone cord, an automatic dialer, wherein the automatic dialer is operatively connected to the housing, and is operatively connected to at least the power supply, and a flashing light;
connecting the telephone cord to an associated phone line; and,
attaching the flashing light to an associated surface, such that when the flashing light is operating, the light is visible from outside an associated building.

16. The method of claim 15, wherein the method further comprises the steps of:
providing a wireless transmitter; and,
providing communication between the wireless transmitter and either the flashing light or the automatic dialer.

17. The method of claim 16, wherein the method further comprises the step of:
providing a two-way communications device.

18. The method of claim 17, wherein the method further comprises the steps of:
depressing a button on the wireless transmitter;
activating the automatic dialer; and,
activating the flashing light.

19. The method of claim 18, wherein activating the automatic dialer further comprises the step of:
contacting emergency personnel.
